(19) United States
(12) Patent Application Publication
(10) Pub. No.: US 2003/0158932 A1
(43) Pub. Date: Aug. 21, 2003

(54) SYSTEM FOR DISPLAYING CONNECTION CONDITION OF DEVICE PROVIDED ON NETWORK

(76) Inventors: HARUO MACHIDA, YOKOHAMA-SHI (JP); KOJI KIKUCHI, YOKOHAMA-SHI (JP)

Correspondence Address: FITZPATRICK CELLA HARPER & SCINTO, 30 ROCKEFELLER PLAZA, NEW YORK, NY, 10112, US

(21) Appl. No.: 09/407,300

(22) Filed: Sep. 29, 1999

(30) Foreign Application Priority Data
Oct. 2, 1998 (JP) 10-281303
Oct. 6, 1998 (JP) 10-284305

(51) Int. Cl. G06F 15/173

(52) U.S. Cl. 709/224

(57) ABSTRACT

An efficiency of a work by using a peripheral device commonly used, or shared on a network is increased. Information data is transmitted/received among a plurality of terminal devices connected to the network so as to acquire connection information of a peripheral device connected to the terminal devices, and also using status information of this peripheral device. Then, the acquired information is stored. Based upon the stored information, all of the terminal devices on the network, the connection information of the peripheral device connected to the terminal device, and the using status information of the peripheral device are displayed. As a result, all of the terminal devices on the network, the connection information of the peripheral device connected to the terminal device, and further the using status information of the peripheral device, which can be displayed on the display screen under easy observation condition.

### BACKGROUND OF THE INVENTION

1. Field of the Invention

The present invention is related to a system for managing a peripheral device provided on a network.

2. Related Background Art

In recent, various systems have been proposed in which a peripheral device such as a printer, a scanner, or a modem is commonly used, or shared on a network such as a LAN.

Since the above peripheral devices are commonly used on such a network, a total cost thereof may be reduced, as well as areas for installing these peripheral devices may be minimized, which are advantageous.

However, in such a commonly-used network system, these peripheral devices are often located at places apart from the places where users are actually working. As a result, the following difficulties occur. The users can hardly grasp which peripheral device is actually connected on the network. Also, the users can grasp the using statuses of these peripheral devices only after documents are actually printed out and images are actually read.

Furthermore, since the connection information etc. about these peripheral devices are separated for every device, the user must every time check these connection statuses of each kind of these peripheral devices. As a result, operation thereof is hard to understand as well as very troublesome, which causes the deterioration of the work efficiency.

Also, a similar problem occurs even in such a case where a peripheral device is commonly used on a network but is not directly connected on this network, and is locally connected to a terminal device such as a personal computer.

### SUMMARY OF THE INVENTION

The present invention has been made to solve the above-explained conventional problems, and therefore, has an object of the invention to provide such a network system capable of increasing the efficiency of a work that is carried out using a peripheral device commonly used on a network.

Another object of the present invention is to provide a network system in which a user of a terminal on a network can readily grasp a peripheral device that is commonly used on the network.

Still another object of the present invention is to provide a network system in which a user of a terminal on a network can readily grasp the status of a peripheral device that is commonly used on this network.

Yet another object of the present invention is to provide a network system in which a user of a terminal on a network can readily grasp a peripheral device that is locally connected to another terminal and is available to use commonly.

Further another object of the present invention is to provide a network system in which a user of a terminal on a network can readily grasp the status of a peripheral device that is locally connected to another terminal and is available to use commonly.

### BRIEF DESCRIPTION OF THE DRAWINGS

FIG. 1 is a block diagram showing an example of an arrangement of a terminal device according to embodiments of the present invention;

FIG. 2 is a flow chart describing an operation example of a terminal device according to a first embodiment of the present invention;

FIG. 3 illustratively indicates an example of a display screen of the terminal device according to the first embodiment of the present invention;

FIG. 4 illustratively shows an example of a data structural example of information acquired by the terminal device according to the first embodiment of the present invention;

FIG. 5 illustratively represents an example of a display screen for setting an information update schedule in the first embodiment of the present invention;

FIG. 6 illustratively indicates the structure of a network system according to a second embodiment of the present invention;

FIG. 7 is a block diagram indicating an internal structure of a terminal device that selects an image reading device in the network system according to the second embodiment of the present invention;

FIG. 8 is a structural diagram representing an example of a display screen of the terminal device that selects the image reading device in the network system according to the second embodiment of the present invention;

FIG. 9 is a flow chart explaining operations of the selecting terminal device in the network system according to the second embodiment of the present invention;

FIG. 10 is a block diagram indicating internal structures of an image reading device and a terminal device that selects the image reading device in a network system of a third embodiment of the present invention;

FIGS. 11A and 11B are flow charts explaining operations of the terminal device that selects the image reading device in the network system according to the third embodiment of the present invention; and

FIG. 12 is a flow chart describing operations of the terminal device to which the image reading device is locally connected in the network system according to the third embodiment of the present invention.

### DESCRIPTION OF THE PREFERRED EMBODIMENTS

Referring now to drawings, an embodiment of the present invention will be described in detail.

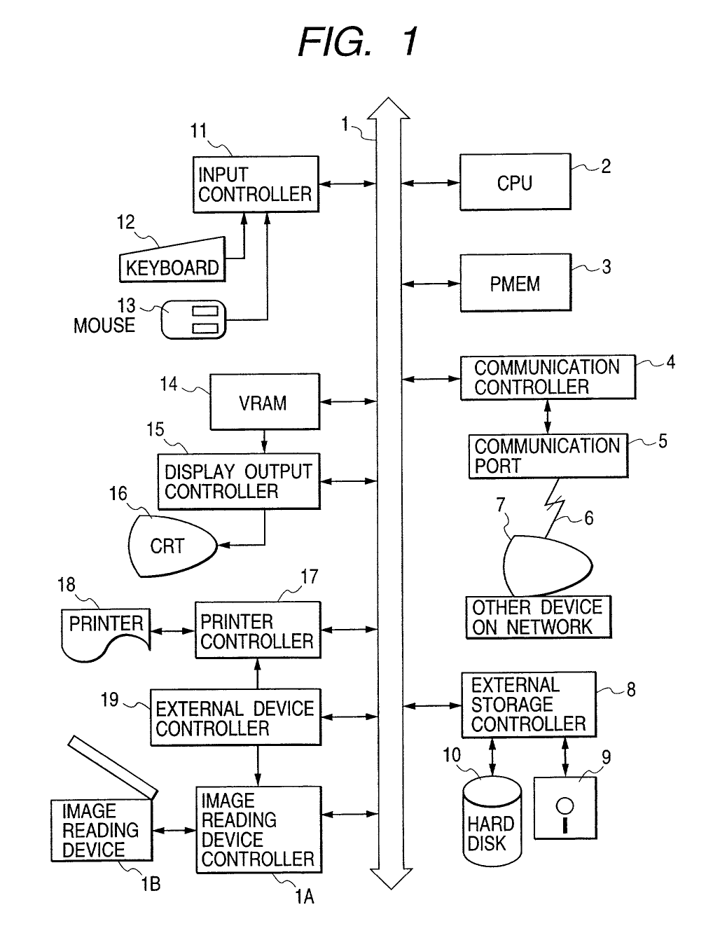

FIG. 1 is a schematic block diagram indicating an arrangement of a terminal device according to embodiments of the present invention.

In this drawing, reference numeral 1 denotes a system bus. Structural blocks (discussed later) are connected to this system bus 1. Reference numeral 2 indicates a CPU (Central Processing Unit).

Reference numeral 3 denotes a program memory (hereinafter referred to as “PMEM”). A program required to execute this process operation is properly selected/read out from a hard disk (unit) 10, and is once stored into this program memory 3 so as to be executed under control of the CPU 2. Also, data entered via a keyboard 12 is stored as code information into the PMEM 3 that also functions as a text memory.

Also, reference numeral 4 shows a communication controller, and this communication controller 4 controls input/output data in a communication port 5. A signal outputted from the communication port 5 is transmitted via a communication line 6 to another communication port of another device 7 provided on the network. Image data are transmitted/received via the above-explained communication controller 4 between a printer 18 and an image reading device 1B, which are commonly used, or shared on the network.

It should be noted that in this first embodiment, the network such as a LAN is described as the above-explained communication line 6, however, the network system of the present invention may be applied to even such a case where both the communication port 5 and the communication line 6, connected to this communication controller 4, are general-purpose public lines.

Also, reference numeral 8 shows an external storage controller, and reference numerals 9 and 10 represent data filing disks. For instance, reference numeral 9 shows a floppy disk (hereinafter referred to as “FD”), and reference numeral 10 indicates a hard disk (hereinafter referred to as “HD”).

Further, reference numeral 11 shows an input controller. An input device such as a keyboard 12 and a mouse 13 is connected to this input controller 11. An operator manipulates this keyboard 12 so as to instruct operations of the network system.

Also, reference numeral 13 represents a pointing device (hereinafter referred to as “PD”) used to instruct processing of image information on a CRT 16. In this first embodiment, the mouse is used as this pointing device. As a result, the operator may arbitrarily move the cursor displayed on the CRT 16 in an X direction and a Y direction and may select a command icon displayed on a command menu so as to instruct a process operation. Furthermore, the operator may instruct an editing object, and a drawing position.

Reference numeral 14 shows a video image memory (hereinafter referred to as “VRAM”), reference numeral 15 indicates a display output controller, and reference numeral 16 represents a CRT (cathode-ray tube). The data displayed on the CRT 16 is expanded as bit map data on the VRAM 14. Reference numeral 17 shows a printer controller. When a printer 18 is connected to the printer controller 17, this printer controller 17 controls this printer 18 to output data.

Reference character 1A denotes an image reading device controller for controlling an image reading device 1B connected thereto. As the terminal device according to this first embodiment, both the image reading device controller 1A and the image reading device 1B are employed. As previously explained, in the terminal device on the side of the client, the above-explained image reading device controller 1A and image reading device 1B may be used which are commonly used via the communication controller 4 and the communication port 5, and are provided on the side of the server terminal.

Furthermore, the arrangement of the network system shown in FIG. 1 may have similar functions even in such a case that an image reading device 1B and the terminal device will constitute physically separate components from each other, and furthermore, the terminal device will constitute such a single component containing the image reading device 1B.

It should be noted that the program stored in the program memory 3 in this first embodiment may be stored in a storage medium such as a hard disk (HD) and a floppy disk (FD), which are directly connected to the terminal device. Alternatively, this program may be stored in another device connected via the network.

Also, the program employed in this first embodiment may be supplied to the storage medium such as the FD 9 and the HD 10, and a system via a network, and also a device via a network.

(First Embodiment)

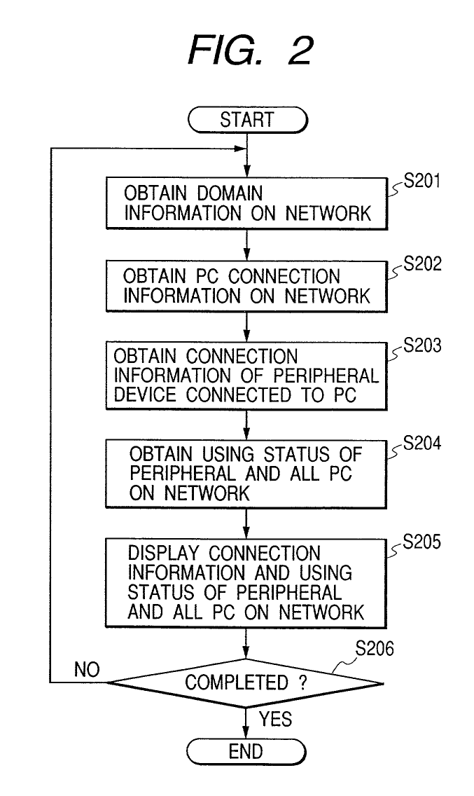

FIG. 2 is a flow chart describing operations of the terminal device according to a first embodiment of the present invention.

As indicated in the flow chart of FIG. 2, domain information on the network to which the own terminal device is connected is acquired under control of the CPU 2 at a first step S201.

At the next step S202, connection information of computers (PCs) connected to the respective domains is acquired.

At the next step S203, connection information of peripheral devices connected to the computers acquired at the previous step S202 is acquired.

Thereafter, using statuses of the above-described computers and peripheral devices are acquired at a step S204. Then, the acquired information is stored in either the memory 3 or the hard disk 10.

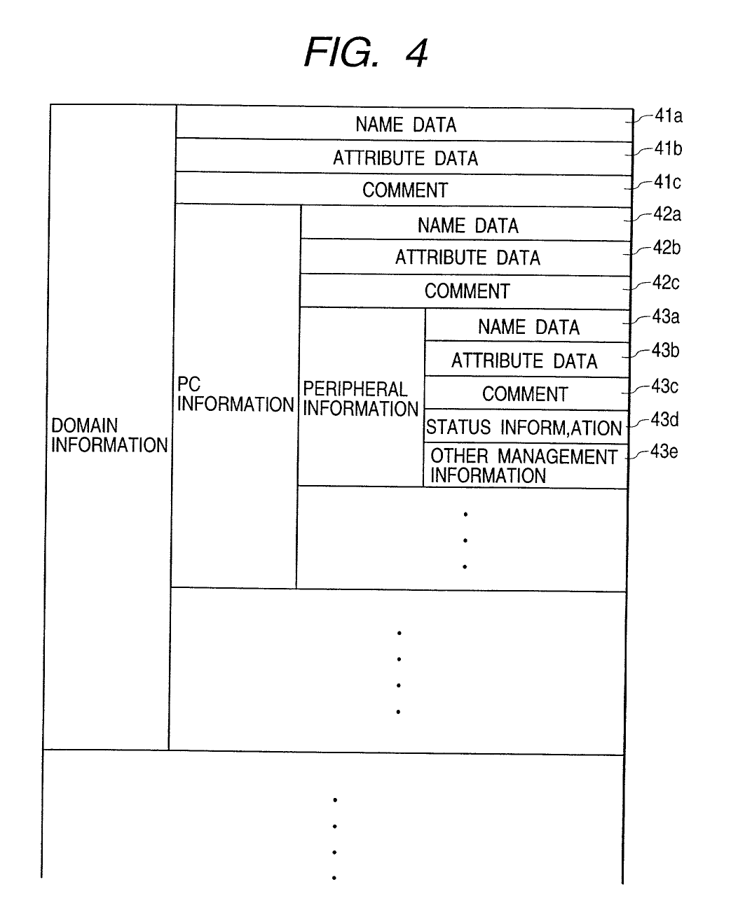

FIG. 4 illustratively shows an example of a data structure obtained in such a case that the connection information and the using statuses acquired at the above-explained steps S203 and S204 are stored in the hard disk and the like. As domain information 41, there are provided name data 41a, attribute data 41b, comment information 41c, and information 42 of the connected computer.

In this case, when a plurality of computers are connected to this domain, this domain owns a plurality of computer information, a total number of which is equal to a total number of the above-explained computers. The computer information 42 contains name data 42a, attribute data 42b, comment information 42c, and information 43 about the connected peripheral devices.

Also, in this case, when a plurality of peripheral devices are connected to this computer, this computer owns a plurality of peripheral device information, a total number of which is equal to a total number of the above-explained peripheral devices. The peripheral device information 43 contains name data 43a, attribute data 43b, comment information 43c, status information 43d, and other management information 43e. It should be understood that structures of information may be slightly different from each other, depending upon the sort of peripheral devices and functions thereof.

Based upon the information acquired at the above-explained step S205, the connection information and the using statuses about all of the computers and peripheral devices, which are connected to the network, are displayed on the display screen of the CRT 16.

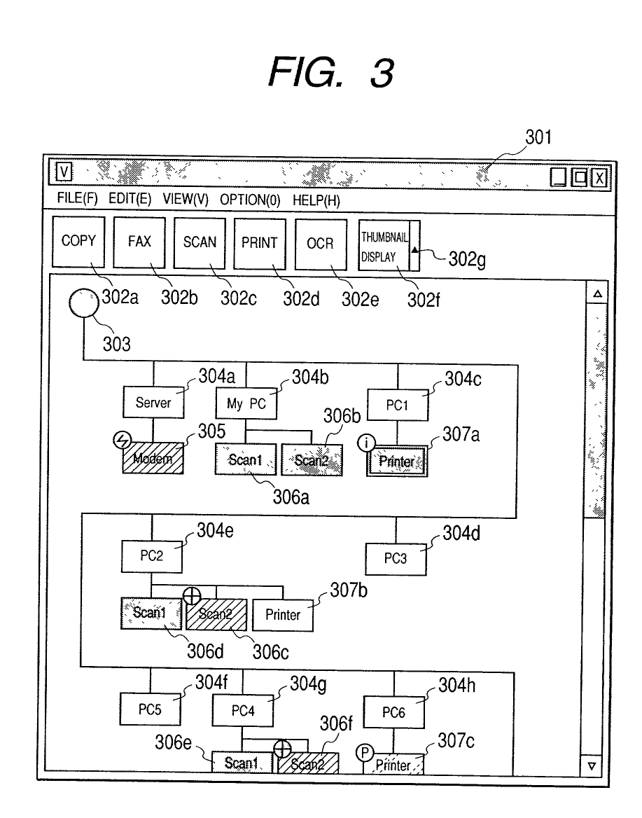

FIG. 3 illustratively shows a display example in the case where both the connection information and the using statuses about the computers and also the peripheral devices are displayed on the CRT 16. In this drawing, reference numeral 301 indicates a window for representing the connection information and the using statuses of all of the devices provided on the network.

Various operations may be carried out by employing the devices displayed on this display screen. In FIG. 3, reference character 302a shows a copy machine, reference character 302b indicates a FAX machine, reference character 302c represents a scanner, reference character 302d is a printer, and reference character 302e shows an OCR (optical character recognition).

Also, reference character 302f represents a button of a display switching function. When this display switching button 302f is clicked, thumbnail display/detail display may be switched. Furthermore, reference character 302g is an information update function button. When this information update function button 302g is operated, both the connection setting information and the using status information about all of the devices provided on the network may be updated.

In this drawing, reference numeral 303 shows a domain. Although only one domain 303 is indicated in this display example, when there are plural domains, all of these domains are indicated.

Also, reference character 304a shows a server machine of this domain 303. Reference character 304b indicates the own computer machine. Reference characters 304c, 304d, 304e, 304f, 304g, and 304h represent other computers connected to the same domain 304, respectively. Also, reference numeral 305 is a modem.

In this display case, a mark, a mesh, and a display shape located at an upper left portion represent a present using status. In this case the mark indicated on the upper left portion shows “under communication”, and a portion where an inclined-line mesh is made indicates such a fact that other machines are under use.

Reference characters 306a, 306b, 306c, 306d, and 306e represent scanners, respectively. The upper left marks 306c and 306f indicate “under scanning”, respectively. Another grey mesh of a device shows such a fact that this device is presently usable. Also, reference characters 307a, 307b, and 307c show printers. An upper left mark of the printer 307a shows that this printer owns a specific function. As this specific function, there are a color printing function, and a staple function or the like.

An upper left mark of the printer 307c indicates “under printing”. A device having no mesh such as the printer 307b indicates such a fact that this device is not presently usable because a driver program is not installed in this device.

Furthermore, a rectangular shape of the printer 307a is indicated by a dual line, which implies that this device is equipped with a composite function such as a printer and also a scanner. As the using statuses of the respective devices, many other using statuses are conducted in this embodiment. For instance, there are such using statuses that although a device is connected to the network, this device is not allowed to be used, and although a printer is operable, a large number of printing jobs are waited for being executed.

In this example, as to the upper left marks and also the rectangular shapes indicative of the devices, the simple marks and the rectangular shapes indicative of the devices are merely varied. Alternatively, the following display method may be conceived. For example, in the case of a scanner, this scanner owns a plurality of display images. Then, these display images may be arbitrarily switched during the scanning operation, and furthermore, the scanner may be scanned by employ moving picture data. Also, further detailed information may be displayed by pointing out the subject while designating by the mouse 13 in all of the devices.

At the next step S206, the terminal device judges whether the display operation is ended, or either the present connection information or the using status information is required to be acquired. As to this judging method, the below-mentioned judging methods may be considered.

As a first judging method, while a predetermined time schedule is saved, the CPU 2 judges whether or not the present time instant is scheduled by this time schedule. That is, in this judging method, the user sets a read setting time instant on the display screen, or sets a read time interval on this display screen. When the present time instant reaches the set time, all of the information provided on the network is again checked, and when either the connection setting condition or the using statuses are changed, the information is again acquired so as to update the previous information.

As the second judging method, a process for monitoring the network is initiated. While the connection setting conditions and the using statuses on the network are continuously monitored, where there is a change in these connection setting conditions and the using statuses, information is again acquired so as to update the previously acquired information.

Also, as the third judging method, a button used to again acquire information is prepared on the display screen. Since the user instructs this button, the information provided on the network at this stage may be acquired so as to update the previously acquired information. The information update function button 302g shown in FIG. 3 corresponds to this button.

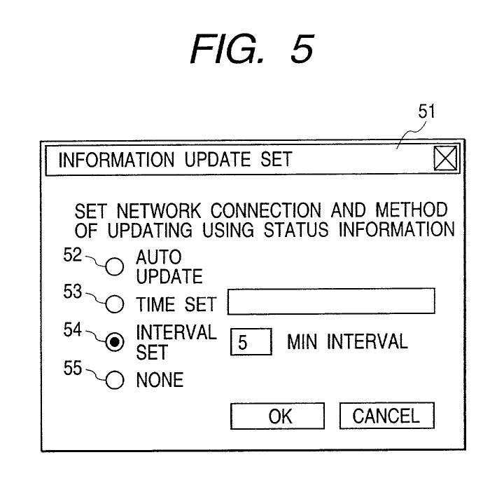

FIG. 5 illustratively shows an example of an information update/setting screen. In FIG. 5, reference numeral 51 indicates a setting screen, and reference numeral 52 represents a button for automatically updating information in the case that the process for monitoring the network is initiated and there is a change in the connection setting condition and the using statuses.

Also, reference numeral 53 shows a button for updating information at a designated time instant. Reference numeral 54 indicates a button for updating information when present time reaches the designated time. Reference numeral 55 represents a button used to update information in such a case that while the information is not automatically updated, the user instructs updating of this information on the display screen.

(Second Embodiment)

Now, a description is made of a system, according to a second embodiment of the present invention, in which an image reading device locally connected to a terminal device provided on a network is commonly used on this network. A terminal device on the network may acquire a list of such terminal devices locally connected to other terminal devices, and then may select a desirable image reading device from this list.

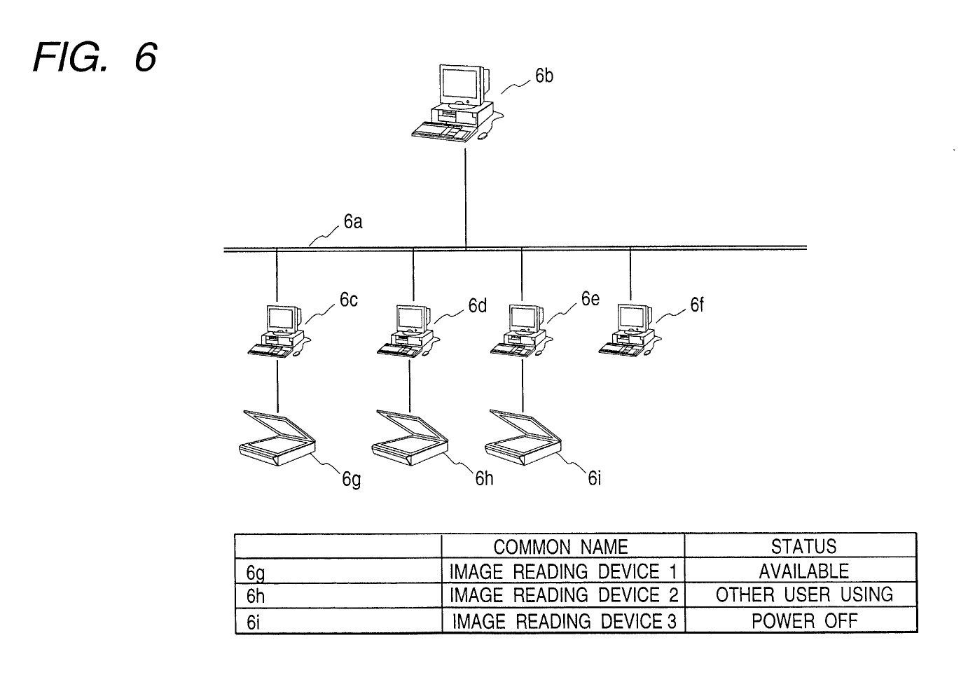

FIG. 6 schematically shows an arrangement of a network system according to the second embodiment.

In FIG. 6, reference character 6a shows a network, reference character 6b indicates a terminal device (hereinafter referred to as “selecting device”) for selecting an image reading device used by a user on this network 6a. Terminal devices 6c, 6d, 6e, and 6f are provided on the network 6a. To these terminal devices 6c, 6d, 6e, image reading devices 6g, 6h, 6i are connected which are available to use commonly. In other words, the respective image reading devices 6g, 6h, 6i are connected to the terminal device 6b as a shared resource (commonly used resource). It is now assumed that both the above-described image reading device and terminal device will constitute an image reading apparatus.

The structural arrangements of the above-explained terminal devices 6b, 6c, 6d, 6e, 6f are identical to these of the terminal devices shown in FIG. 1.

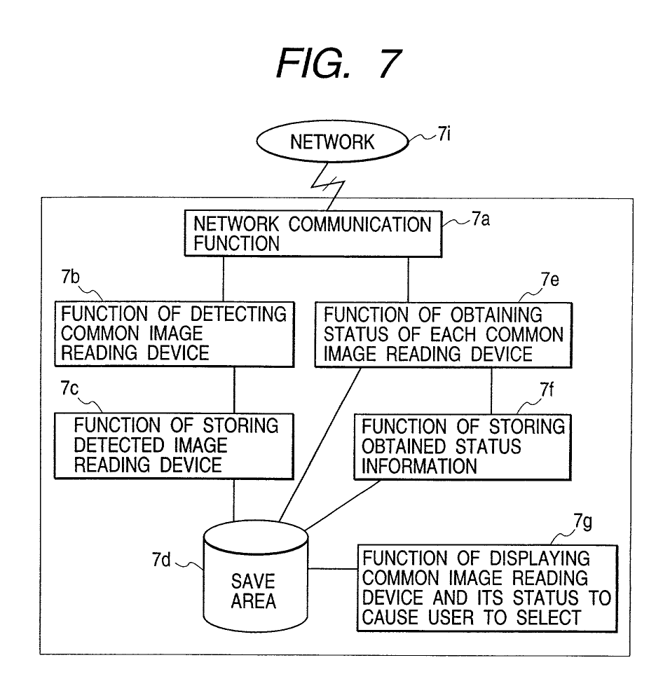

FIG. 7 schematically indicates an arrangement of an internal function of the terminal device 6b.

In FIG. 7, reference character 3a is a network communication function for processing all of network communications of this device. Reference character 7b shows a detecting function for detecting the image reading devices 6g, 6h, 6i of FIG. 6. Reference character 7c shows a saving function for saving the image reading device detected by the detecting function 7b in a storage area 7d. As a result, the image reading devices 6g, 6h, 6i of the commonly-used image reading apparatus are saved in the list of a storage area 7d.

Reference character 7e indicates an acquiring function for acquiring current using statuses of the image reading devices 6g, 6h, 6i registered in the image reading apparatus list saved in the storage area 7d. Although there is no limitation in the sort of using statuses, various using statuses may be conceived, for example, “available” “busy”, “power OFF”, “not available due to security”. In the case of FIG. 6, the image reading device 6g is stored as “available”; the device 6h is stored as “busy”; and the device 6i is stored as “power supply OFF”.

Reference character 7f shows a storing function for storing the information acquired by the acquiring function 7e into the storage area 7d. Reference character 7g is a selecting function. This selecting function 7g calls the process operations of the respective functions 7a to 7h, and acquires the commonly-used image reading device and the using status thereof, which are stored in the storage area 7d. Then, the user selects/displays the selected screen of the image reading device.

Since the process operations of the respective function units 7a to 7h are timely required when the selecting function 7g is selected, the network system is initiated by calling the process operation of the selecting function 7g.

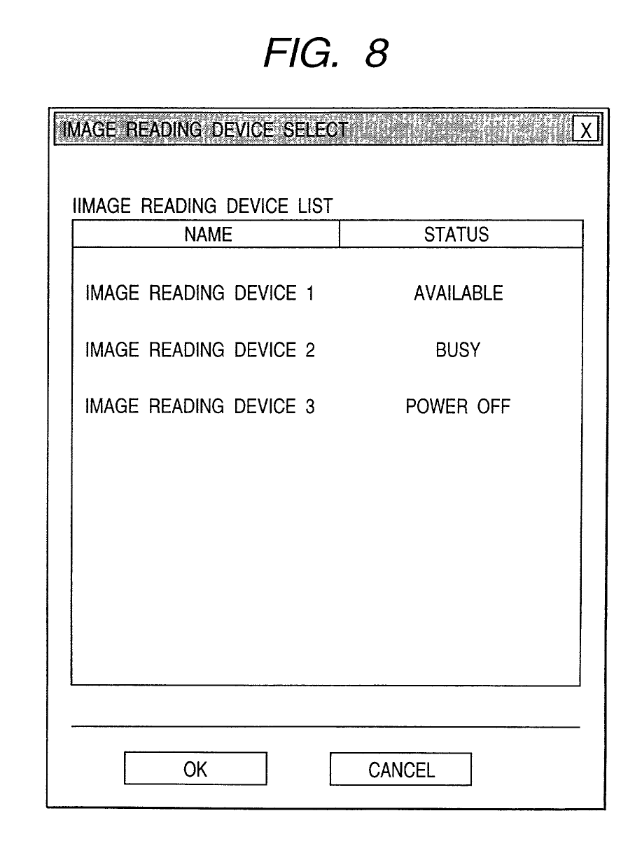

FIG. 8 represents an example for showing the process operation of the above-explained selecting function 7g.

In FIG. 8, the commonly-used image reading devices 1 to 3 are displayed on name portions of an image reading device list. As apparent from this representation, the image reading device 1 is “usable”, the image reading device 2 is “under use by other users”; and the image reading device 3 is “power supply OFF”. Therefore, the user can easily select the immediately operable image reading device.

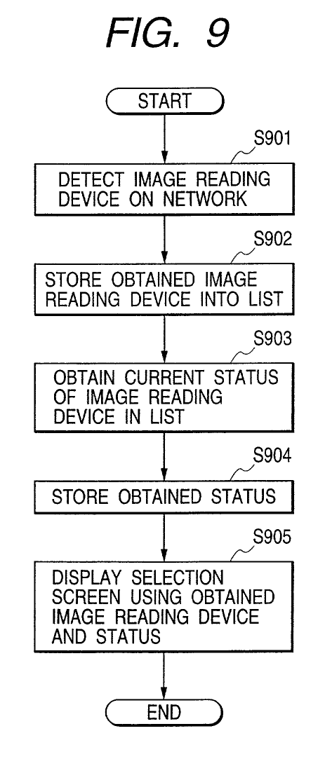

FIG. 9 is a flow chart describing operations of the terminal device 6b.

First, when the user calls the selecting process of the image reading device, the image reading device on the network is detected at a step S901. At the next step S902, the acquired image reading device is stored in the list. Next, the present information about the respective image reading devices is acquired by using this stored list at a step S904. Thereafter, the acquired information at the step S904 is stored. Then, a screen to be selected by the user is displayed by using the stored information at a step S905.

(Third Embodiment)

Next, a third embodiment of the present invention is explained.

In the above-explained second embodiment, the information of all of the image reading devices is acquired by the selecting device 6b. In this third embodiment, such a function for regularly notifying each information to the selecting device 6b is provided on the side of the image reading device. Also, since this selecting device 6b is provided with another function for acquiring this notification to store this acquired notification, the time required to acquire such information may be shortened. Only different structures from those of the second embodiment will now be described.

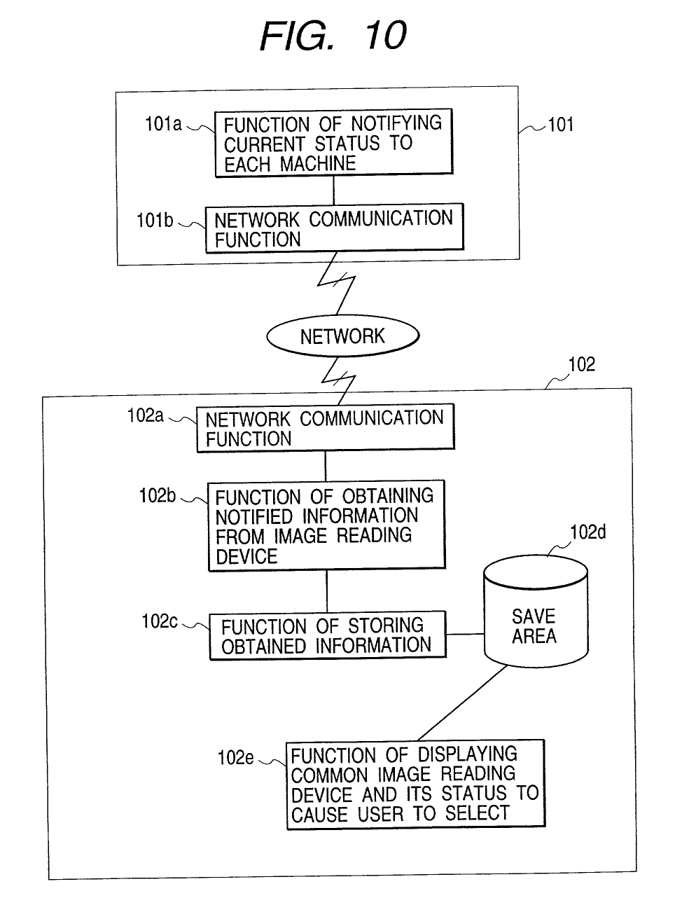

FIG. 10 is a structural diagram for showing internal functions of each terminal device and each image reading device according to this third embodiment.

Reference numeral 101 is an image reading device, and reference numeral 102 shows a terminal device 6b for selecting one of the image reading devices.

In the image reading device 101, reference character 101a shows a function for notifying the current own status to the respective machines provided on a network. Reference character 101b shows a network communication function.

In the selecting device 102, reference character 102a shows a network communication function for communicating with the communication function 101b of the image reading device 101. Reference character 102b is an acquiring function for acquiring information notified from the image reading device 101. Reference character 102c shows a storing function for storing the acquired information into a save area 102d. Reference character 102e represents a selecting function. This selecting function 102e is initiated when the user calls a selecting process of an image reading device, and displays the image reading device and the status information thereof, which are saved in the save area 102d, on the display screen for selection purposes.

Comparing with the selecting function 7g of the second embodiment, the above-explained selecting function 102e merely acquires/displays the information saved in the save area 102d, but does not perform the retrieve process operation nor the information acquisition process operation. As a consequence, this selecting function 102e can execute this process operation in higher speeds.

Next, operations of the terminal device 6b will now be explained.

Since the image reading device executes only such a process operation for continuously notifying a status thereof to the respective machines at timing when the own status is changed, descriptions thereof are omitted.

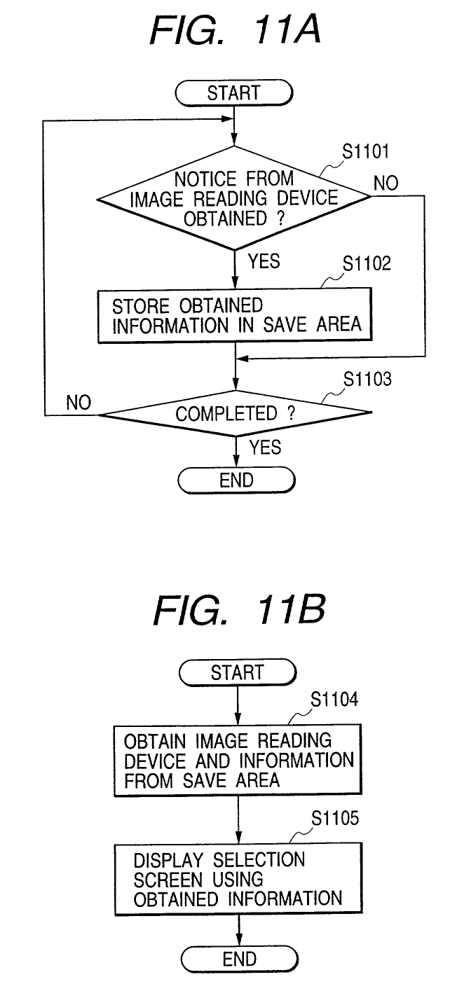

FIGS. 11A and 11B are flow charts for explaining operations of the terminal device for selecting the image reading device. A flow chart of FIG. 11A indicates such a process operation that while the process operation is initiated in the background process, the information notified from the image reading device is continuously monitored, and when the information is acquired, the acquired information is saved in the save area.

At a step S1101, a determination is made whether or not the notification issued from the image reading device is acquired. When this notification is acquired, this acquired notification is saved in the save area. A step S1103 corresponds to a process operation for determining whether or not the background process operation is accomplished. Until the ending process is selected, the loop process is carried out.

FIG. 11B is such a flow chart for explaining operations when the image reading device is selected by the user. When the image reading device is selected by the user, the information saved at the above step S1102 is acquired from the save area at a step S1104.

Then, at a step S1105, a selection screen of the image reading device is displayed by employing the acquired information. Thereafter, when the user performs the selecting operation of the desirable image reading device from the selecting screen, a set-up operation is initiated so as to use the selected image reading device. Then, this set-up image reading device can be used via the network.

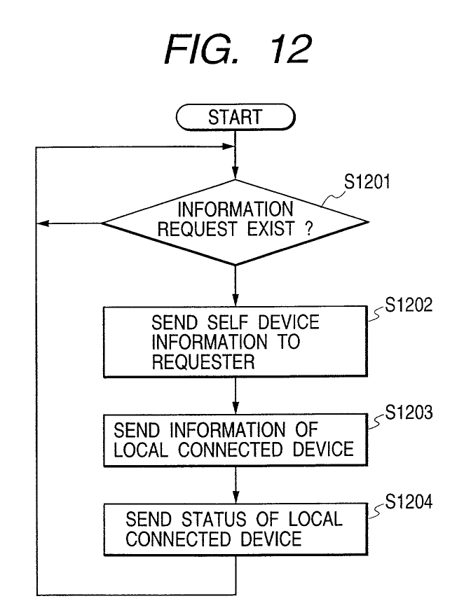

FIG. 12 is a flow chart for explaining operations of the terminal device to which the image reading device is locally connected, according to the third embodiment.

At a first step S1201, a check is made whether or not an information request is issued from the terminal device on the network. When this information request is issued, the process operation is advanced to a step S1202. At this step S1202, the information of the own apparatus saved in the hard disk is transmitted to the terminal device of the request issuing source. At a step S1203, the information of the image reading device locally connected thereto, which is saved in the hard disk, is transmitted to the above-explained terminal device of the request issuing source. At a step S1204, a status of a peripheral device locally connected to the image reading device is detected, and then the detected status is sent to the terminal device of the request issuing source.

It should be noted that in this flow chart the information is transmitted in response to the request issued from another terminal device. Alternatively, the information may be spontaneously transmitted to the respective terminal devices on the network every time a predetermined time interval has passed.

It should be also noted that the present invention may be applied not only to a system arranged by a plurality of devices (for example, host computer, interface device, reader, printer), but also to an apparatus constructed of a single device.

While various sorts of devices are operated so as to realize the above-explained functions of the above embodiment modes, a program code of software for realizing the above-explained functions is supplied to either an apparatus connected to these various devices or a computer in a system, and these various devices are operated in accordance with the program saved in the computer (CPU, MPU) of this system, or this apparatus, which may be apparently covered by the technical scope of the present invention.

In this case, the program code itself of the above-described software may realize the functions of the above-explained embodiment modes. In this case, this program code itself, and a means for supply this program code to the computer, for example, a storage medium for storing this program code constitute the present invention. As a storage medium for storing this program code, there are provided a floppy disk, a hard disk, an optical disk, an opto-magnetic disk, a CD-ROM, a magnetic tape, and a non-volatile memory card, and a ROM may be employed.

Not only the functions of the above-described embodiment modes may be realized by executing the program supplied to the computer, but also the functions of these embodiment modes may be realized by such an OS (operating system) of which program code is operated in the computer, or by executing the supplied program code in conjunction with another application software, which may be covered by the technical scope of the present invention.

Furthermore, after the supplied program code has been stored into a computer function extended board, or a memory employed in a function extended unit connected to the computer, a CPU provided in this function extended board or function extended unit executes a portion of the actual process operation, or the entire portion thereof based on an instruction of this program code, and thus, the functions of the above-described embodiments may be realized by this process operation, which may be similarly covered by the technical scope of the present invention.

In accordance with the above-described embodiment, as previously explained, all of the terminal devices commonly used on the network, the connection information of the peripheral device connected to the terminal devices, and the using status information thereof can be displayed on the display screen under easy observation condition and a discriminatable condition. As a result, all of the devices connected to the network can be effectively utilized. Therefore, the work efficiency for using the peripheral device commonly used on the network can be increased.

Also, according to the embodiment, the condition of the image reading device commonly used on the network is acquired to be displayed on the image reading device selecting screen. As a consequence, the user can readily select the presently available image reading device, so that the work efficiency can be increased.

What is claimed is:

1. An information processing apparatus connected to a network, comprising:
communicating means for communicating information with each of terminal devices on said network;
first acquiring means for acquiring information related to the terminal device connected to said network;
second acquiring means for acquiring information related to a peripheral device which is locally connected to the terminal device whose information is acquired by said first acquiring means;
third acquiring means for acquiring a status of the peripheral device whose information is acquired by said second acquiring means; and
display means for displaying information of a terminal device connected to said network, information of a peripheral device connected to said terminal device, and a status thereof based upon the information acquired by said first acquiring means, the information acquired by said second acquiring means, and the status acquired by said third acquiring means.

2. An information processing apparatus according to claim 1 wherein:
said first acquiring means, said second acquiring means, and said third acquiring means poll the terminal device on said network to acquire both the information and the status thereof every time a predetermined time period has passed; and
said display means updates the display content based upon said polling-acquired information and condition.

3. An information processing apparatus according to claim 1 wherein:
said first acquiring means, said second acquiring means, and said third acquiring means poll the terminal device on said network to acquire both the information and the status thereof in response to a predetermined operation made by a user; and
said display means updates the display content based upon said polling-acquired information and condition.

4. An information processing apparatus according to claim 1 wherein:
said first acquiring means, said second acquiring means, and said third acquiring means receive and obtain both the information and the condition notified from the terminal device on said network; and
said display means updates the display content based upon said notified information and condition.

5. An information processing apparatus according to claim 1, further comprising:
selecting means for selecting a desirable peripheral device by a user from the peripheral devices displayed by said display means; and wherein:
a step-up operation for using the selected peripheral device is carried out in response to the selecting operation by the user via said selecting means.

6. An information processing apparatus according to claim 1 wherein:
said peripheral device is a printer device.

7. An information processing apparatus according to claim 1 wherein:
said peripheral device is a modem device.

8. An information processing apparatus according to claim 1 wherein:
said peripheral device is an image input device.

9. An information processing apparatus according to claim 1 wherein:
said first acquiring means acquires information of a terminal device within a predetermined network domain.

10. An information processing apparatus according to claim 1 wherein:
said display means displays a terminal device and a peripheral device, which are displayed, by way of display elements; and also displays a connection condition thereof by connecting the respective display elements to each other on a display screen thereof.

11. An information processing apparatus according to claim 10 wherein:
said display means displays thereon the connection condition of said peripheral device based upon a sort of lines used to connect the terminal device with the peripheral device.

12. An information processing apparatus according to claim 10 wherein:
when said display means displays the condition of the peripheral device, said display means selects an icon corresponding to said condition of the peripheral device from a predetermined icon group to display said selected icon.

13. An information processing apparatus according to claim 12 wherein:
said icon group contains an icon for indicating that a peripheral device is busy, and also another icon for representing that a peripheral device is not under use.

14. An information processing apparatus according to claim 12 wherein:
said icon group contains an icon for representing the condition of the peripheral device by way of a moving picture representation.

15. An information processing apparatus according to claim 12 wherein:
said icon group contains an icon for representing the condition of the peripheral device by way of a mesh thereof.

16. An information processing apparatus according to claim 12 wherein:
said icon group contains an icon for indicating that a driver program for controlling a peripheral device is not installed in the own device.

17. An information processing apparatus connected to a network, comprising:
first saving means for saving information of the own device on said network;
connecting means for locally connecting a peripheral device thereto;
second saving means for saving information of said peripheral device connected by said connecting means;
detecting means for detecting a condition of said peripheral device connected by said connecting means; and transmitting means for transmitting the information saved in said first saving means, the information saved in said second saving means, and the condition detected by said detecting means to another device in response to a request issued from said another device.

18. An information processing apparatus connected to a network, comprising:
first saving means for saving information of the own device on said network;
connecting means for locally connecting a peripheral device thereto;
second saving means for saving information of said peripheral device connected by said connecting means;
detecting means for detecting a condition of said peripheral device connected by said connecting means; and transmitting means for transmitting the information saved in said first saving means, the information saved in said second saving means, and the condition detected by said detecting means to another device on said network in a periodic manner.

19. A system in which at least a first information processing apparatus and a second information processing apparatus are connected to a network, wherein:
said first information processing apparatus is comprised of:
first acquiring means for acquiring information related to the first information processing apparatus connected to said network;
second acquiring means for acquiring information related to a peripheral device which is locally connected to the first information processing apparatus whose information is acquired by said first acquiring means;
third acquiring means for acquiring a status of the peripheral device whose information is acquired by said second acquiring means; and
display means for displaying information of the first information processing apparatus connected to said network, information of a peripheral device connected to said first information processing apparatus, and a status thereof based upon the information acquired by said first acquiring means, the information acquired by said second acquiring means, and the status acquired by said third acquiring means; and wherein:
said second information processing apparatus is comprised of:
first saving means for saving information of the own device on said network;
connecting means for connecting a peripheral device thereto;
second saving means for saving information of said peripheral device connected by said connecting means;
detecting means for detecting a condition of said peripheral device connected by said connecting means; and transmitting means for transmitting the information saved in said first saving means, the information saved in said second saving means, and the condition detected by said detecting means to said first information processing apparatus.

20. A system according to claim 19 wherein:
said first acquiring means, said second acquiring means, and said third acquiring means poll the first and second information processing apparatuses on said network to acquire both the information and the status thereof every time a predetermined time period has passed; and
said display means updates the display content based upon said polling-acquired information and condition.

21. A system according to claim 19 wherein:
said first acquiring means, said second acquiring means, and said third acquiring means poll the first and second information processing apparatuses on said network to acquire both the information and the status thereof in response to a predetermined operation made by a user; and said display means updates the display content based upon said polling-acquired information and condition.

22. A system according to claim 19 wherein:
said first acquiring means, said second acquiring means, and said third acquiring means receive and obtain both the information and the status notified from the first and second information processing apparatuses on said network; and
said display means updates the display content based upon said notified information and condition.

23. A system according to claim 19, further comprising:
selecting means for selecting a desirable peripheral device by a user from the peripheral devices displayed by said display means; and wherein:
a step-up operation for using the selected peripheral device is carried out in response to the selecting operation by the user via said selecting means.

24. A system according to claim 19 wherein:
said peripheral device is a printer device.

25. A system according to claim 19 wherein:
said peripheral device is a modem device.

26. A system according to claim 19 wherein:
said peripheral device is an image input device.

27. A system according to claim 19 wherein:
both said first information processing apparatus and said second information processing apparatus belong to a predetermined network domain; and
said first acquiring means acquires information of the first and second information processing apparatuses within a predetermined network domain.

28. A system according to claim 20 wherein:
said display means displays the first/second information processing apparatuses and the peripheral device, which are displayed, by way of display elements; and also displays a connection condition thereof by connecting the respective display elements to each other on a display screen thereof.

29. A system according to claim 28 wherein:
said display means displays thereon the connection condition of said peripheral device based upon a sort of lines used to connect the terminal device with said peripheral device.

30. A system according to claim 28 wherein:
when said display means displays the condition of the peripheral device, said display means selects an icon corresponding to said condition of the peripheral device from a predetermined icon group to display said selected icon.

31. A system according to claim 30 wherein:
said icon group contains an icon for representing the condition of the peripheral device by way of a moving picture representation.

32. A system according to claim 30 wherein:
said icon group contains an icon for representing the condition of the peripheral device by way of a mesh thereof.

33. A system according to claim 30 wherein:
said icon group contains an icon for indicating that a peripheral device is busy, and also another icon for representing that a peripheral device is not busy.

34. A system according to claim 30 wherein:
said icon group contains an icon for indicating that a driver program for controlling a peripheral device is not installed in the own device.

35. A system according to claim 30 wherein:
said peripheral device is a printer device; and
said icon group contains such an icon which indicates that a plurality of print jobs are pending.

36. A method for displaying information of a peripheral device locally connected to a terminal device connected to a network, comprising the steps of:
acquiring first information related to the terminal device connected to said network;
acquiring second information related to the peripheral device that is locally connected to the terminal device whose first information is acquired;
acquiring third information related to the condition of the peripheral device whose second information is acquired; and
displaying a connection status display indicative of information of the terminal device connected to said network, information of the peripheral device connected to said terminal device, and the status thereof based upon the first information, the second information, and the third information.

37. A display method according to claim 36 wherein:
said first information, said second information, and said third information are acquired by polling the terminal device on said network to acquire both the information and the status thereof every time a predetermined time period has passed; and
the content of said connection status display is updated by the display content based upon said polling-acquired information and condition.

38. A display method according to claim 36 wherein:
said first information, said second information, and said third information are acquired by polling the terminal device on said network to acquire both the information and the status thereof in response to a predetermined operation made by a user; and the display content of said connection status display is updated by the display content based upon said polling-acquired information and condition.

39. A display method according to claim 36, further comprising the steps of:
receiving and obtaining said first information, said second information, and said third information notified from the terminal device on said network; and
updating the display content of the connection status display based upon said notified information and condition.

40. A display method according to claim 36, further comprising the step of:
selecting a desirable peripheral device by a user from the peripheral devices displayed on said connection state display; and wherein:
a step-up operation for using the selected peripheral device is carried out in response to the selecting operation of the peripheral device by the user via said selecting means.

41. A display method according to claim 36 wherein:
said peripheral device is a printer device.

42. A display method according to claim 36 wherein:
said peripheral device is a modem device.

43. A display method according to claim 36 wherein:
said peripheral device is an image input device.

44. A display method according to claim 36 wherein:
said first information is acquired from a terminal device within a predetermined network domain.

45. A display method according to claim 36 wherein:
to display the connection status display, a terminal device and a peripheral device, which are displayed, are expressed by way of display elements; and also the connection status is displayed by connecting the respective display elements to each other on a display screen thereof.

46. A display method according to claim 45 wherein:
the connection status of said peripheral device is displayed based upon a sort of lines used to connect the terminal device with the peripheral device.

47. A display method according to claim 45 wherein:
when the condition of the peripheral device is displayed, an icon corresponding to said condition of the peripheral device is selected from a predetermined icon group to display said selected icon, to display the connection status display.

48. A display method according to claim 47 wherein:
said icon group contains an icon for representing the condition of the peripheral device by way of a moving picture representation.

49. A display method according to claim 47 wherein:
said icon group contains an icon for representing the condition of the peripheral device by way of a mesh thereof.

50. A display method according to claim 47 wherein:
said icon group contains an icon for indicating that a peripheral device is busy, and also another icon for representing that a peripheral device is not busy.

51. A display method according to claim 47 wherein:
said icon group contains an icon for indicating that a driver program for controlling a peripheral device is not installed in the own device.

52. A method for displaying information of a peripheral device locally connected to an information processing apparatus connected with a network, comprising the steps of:
saving first information relating to the own device on said network;
saving second information relating to said peripheral device locally connected thereto;
detecting a condition of said peripheral device connected thereto; and
transmitting the first information, the second information, and the condition of said peripheral device to another device based upon a request issued from another device on said network.

53. A method for displaying information of a peripheral device locally connected to an information processing apparatus connected with a network, comprising the steps of:
saving first information relating to the own device on said network;
saving second information relating to said peripheral device locally connected thereto;
detecting a condition of said peripheral device connected thereto; and
transmitting the first information, the second information, and the condition of said device to another device on said network in a periodic manner.

54. A method for displaying information of a peripheral device locally connected to a terminal device connected with a network, comprising the steps of:
acquiring first information relating to a information processing apparatus connected to said network;
acquiring second information relating to the peripheral device which is locally connected to the terminal device whose first information is acquired;
acquiring third information related to a status of the peripheral device whose second information is acquired; and
displaying a connection status display indicative of information of the terminal device connected to said network, information of the peripheral device connected to said terminal device, and a status thereof based upon the first information, the second information, and the third information in the first information processing apparatus; and also comprising the steps of:
saving information of the own device on said network;
saving information relating to said peripheral device locally connected thereto;
detecting a condition relating to said peripheral device connected by said connecting means; and
transmitting the information related to said own device, the information related to said peripheral device, and the condition of said peripheral device to said first information processing apparatus in a second information processing apparatus.

55. A display method according to claim 54 wherein;
said first information, said second information, and said third information are acquired by polling the information processing apparatuses on said network to acquire both the information and the status thereof every time a predetermined time period has passed; and
the content of said connection status display is updated by the display content based upon said polling-acquired information and condition.

56. A display method according to claim 54 wherein;
said first information, said second information, and said third information are acquired by polling the information processing apparatuses on said network to acquire both the information and the status thereof in response to a predetermined operation made by a user; and the display content of said connection status display is updated by the display content based upon said polling-acquired information and condition.

57. A display method according to claim 54 wherein:
said first information, said second information, and said third information are acquired by receiving both the information and the condition notified from the first and second information processing apparatuses on said network; and
the display content of said connection status display is updated based on said notified information and status.

58. A display method according to claim 5, further comprising a step of:
selecting a desirable peripheral device by a user from the peripheral devices displayed on said connection status display, wherein:
a step-up operation for using the selected peripheral device is carried out in response to the selecting operation of the peripheral device by the user via said selecting means.

59. A display method according to claim 54 wherein:
said peripheral device is a printer device.

60. A display method according to claim 54 wherein:
said peripheral device is a modem device.

61. A display method according to claim 54 wherein:
said peripheral device is an image input device.

62. A display method according to claim 54 wherein:
both said first information processing apparatus and said second information processing apparatus belong to a predetermined network domain; and
said first information processing apparatus acquires said first information from an information processing apparatus within said predetermined network domain.

63. A display method according to claim 54 wherein:
to display the connection status display, the information processing apparatuses and a peripheral device, which are displayed, are represented by way of display elements; and also the connection status is displayed by connecting the respective display elements to each other on a display screen thereof.

64. A display method according to claim 54 wherein:
the connection status of said peripheral device is displayed based upon a sort of lines used to connect the terminal device with the peripheral device.

65. A display method according to claim 54 wherein:
when the condition of the peripheral device is displayed, an icon corresponding to said condition of the peripheral device is selected from a predetermined icon group to display said selected icon, to display the connection status display.

66. A display method according to claim 65 wherein:
said icon group contains an icon for representing the condition of the peripheral device by way of a moving picture representation.

67. A display method according to claim 65 wherein:
said icon group contains an icon for representing the condition of the peripheral device by way of a mesh thereof.

68. A display method according to claim 65 wherein:
said icon group contains an icon for indicating that a peripheral device is busy, and also another icon for representing that a peripheral device is not busy.

69. A display method according to claim 65 wherein:
said icon group contains an icon for indicating that a driver program for controlling a peripheral device is not installed in the own device.

70. A display method according to claim 65 wherein:
said peripheral device is a printer device; and
said icon group contains such an icon that indicates that a plurality of print jobs are pending.

71. A storage medium for storing thereinto a computer program executed by a computer employed in an information processing apparatus connected to a network, wherein:
said computer program is comprised of:
a process operation for acquiring first information related to a terminal device connected to said network;
a process operation for acquiring second information related to a peripheral device which is locally connected to the terminal device whose first information is acquired;
a process operation for acquiring third information related to a status of the peripheral device whose second information is acquired; and
a process operation for displaying a connection status display indicative of information of said terminal device connected to said network, information of the peripheral device connected to said terminal device, and a status thereof based upon the first information, the second information, and the third information.

72. A storage medium according to claim 71 wherein:
said first information, said second information, and said third information are acquired by polling the terminal device on said network to acquire both the information and the status thereof every time a predetermined time period has passed; and
the content of said connection status display is updated by the display content based upon said polling-acquired information and condition.

73. A storage medium according to claim 71 wherein:
said first information, said second information, and said third information are acquired by polling the terminal device on said network to acquire both the information and the status thereof in response to a predetermined operation made by a user; and the display content of said connection status display is updated by the display content based upon said polling-acquired information and condition.

74. A storage medium according to claim 71 wherein:
said first information, said second information, and said third information are acquired by receiving both the information and the status notified from the terminal device on said network; and
a display content of said connection status display is updated based upon said notified information and said notified status.

75. A storage medium according to claim 71, further comprising:
a process operation for selecting a desirable peripheral device by a user from the peripheral devices displayed on said connection status display; and wherein:
step-up operation for using the selected peripheral device is carried out in response to the selecting operation of the peripheral device by the user via said selecting means.

76. A storage medium according to claim 71 wherein:
said peripheral device is a printer device.

77. A storage medium according to claim 71 wherein:
said peripheral device is a modem device.

78. A storage medium according to claim 71 wherein:
said peripheral device is an image input device.

79. A storage medium according to claim 71 wherein:
said first information processing apparatus acquires information of a terminal device within a predetermined network domain.

80. A storage medium according to claim 71 wherein:
as to said connection status display, a terminal device and a peripheral device, which are displayed, are represented by way of display elements; and also a connection condition thereof is displayed by connecting the respective display elements to each other on a display screen thereof.

81. A storage medium according to claim 80 wherein:
the connection condition of said peripheral device are displayed by way of a sort of lines used to connect the terminal device with the peripheral device.

82. A storage medium according to claim 80 wherein:
as to said connection status display, when the condition of the peripheral device is displayed, an icon corresponding to said condition of the peripheral device is selected from a predetermined icon group to display said selected icon.

83. A storage medium according to claim 82 wherein:
said icon group contains an icon for representing the condition of the peripheral device by way of a moving picture representation.

84. A storage medium according to claim 82 wherein:
said icon group contains an icon for representing the condition of the peripheral device by way of a mesh thereof.

85. A storage medium according to claim 82 wherein:
said icon group contains an icon for indicating that a peripheral device is busy, and also another icon for representing that a peripheral device is not busy.

86. A storage medium according to claim 82 wherein:
said icon group contains an icon for indicating that a driver program for controlling a peripheral device is not installed in the own device.

87. A storage medium for storing thereinto a computer program executed by a computer employed in an information processing apparatus connected to a network, wherein:
said computer program is comprised of:
a process operation for saving first information relating to the own device on said network;
a process operation for saving second information relating to said peripheral device locally connected thereto;
a process operation for detecting a condition of said peripheral device connected thereto; and
a process operation for transmitting the first information, the second information, and the detected condition to another device based upon a request issued from said another device on said network.

88. A storage medium for storing thereinto a computer program executed by a computer employed in an information processing apparatus connected to a network, wherein:
said computer program is comprised of:
a process operation for saving first information relating to the own device on said network;
a process operation for saving second information relating to said peripheral device locally connected thereto;
a process operation for detecting a condition of said peripheral device connected thereto; and
a process operation for transmitting the first information, the second information, and the detected condition to another device on said network in a periodic manner.
